(19) United States
(12) Patent Application Publication
(10) Pub. No.: US 2012/0160212 A1
(43) Pub. Date: Jun. 28, 2012

(54) INTAKE DEVICE FOR ENGINE

(76) Inventors: Kazuhiro Maki, Tokyo (JP); Chikaya Ito, Tokyo (JP)

(21) Appl. No.: 13/386,170

(22) PCT Filed: Aug. 25, 2010
(86) PCT No.: PCT/JP2010/064338

§ 371 Date: Mar. 19, 2012

(30) Foreign Application Priority Data
Oct. 8, 2009 (JP) 2009-234450

(51) Int. Cl. F02D 9/08

(52) U.S. Cl. 123/403

(57) ABSTRACT

It is intended to provide a device for lowering a cost of the throttle body of the carburetor that can be used for both the mechanical governor control device and the electronic governor control device. A bracket 5 on which a stepper motor 7 which opens and closes a throttle valve 6 of a carburetor 2 is provided between adjacent two of an air cleaner 1 arranged in an intake path 12 of the engine, the carburetor 2, a first thermal insulator and the intake path 4 of the engine which together form the intake path 12.

### TECHNICAL FIELD

The present invention relates to an intake device for an engine, and in particular to a mounting device for mounting an actuator which drives a throttle valve of a carburetor.

### BACKGROUND ART

A mechanical governor having a weight and a spring is commonly used to regulate an engine rotation speed of an internal combustion engine.

In the mechanical governor, a link mechanism transmits link motion to a rotation shaft of a throttle valve based on a rotation speed of the engine to drive the throttle valve. In this manner, the mechanical governor regulates the rotation speed of the engine by adjusting percentage of fuel in a mixture and an intake mount of fuel to be introduced to a combustion chamber of the engine.

In some cases, an engine equipped with an electronic governor is used to regulate the rotation speed of the engine with precision. The electronic governor regulates the rotation speed of the engine with precision by means of an electronic actuator in which an actuator such as a linear solenoid and a stepper motor is connected to the rotation shaft of the throttle valve of the carburetor.

Patent Literature 1, JP2005-133655A proposes a throttle valve control device 01 for an engine using an electronic governor control device as shown in FIG. 6.

The throttle valve control device 01 of Patent Literature 1 includes a throttle valve inside for adjusting an amount of intake air to the internal combustion engine. In the throttle valve control device 01, a throttle body 03, a gearbox 05, a sensor cover 06 and a motor housing 07 are formed integrally. The throttle body 03 rotatably supports a drive shaft 04 for rotating the throttle valve 02. The gear box 05 is formed integrally with the throttle body 03 on an outer periphery of the throttle body 03 and houses a reduction gear (not shown) which is connected to one end of the rotation shaft 04 of the throttle valve 02 to drive the throttle valve in a opening-closing direction. The sensor cover 06 is provided to hold a sensor (not shown) or the like for detecting a rotation angle of the throttle valve 02. The motor housing 07 is formed integrally with the throttle body on the outer periphery of the throttle body 03 and has a rotation axis being approximately parallel to the rotation shaft 04 of the throttle valve and supports a motor (not shown) which is a drive source of the throttle valve 02. The output shaft of the motor and the reduction gear are connected to drive the reduction gear freely of turning clockwise and counterclockwise.

### CITATION LIST

### Patent Literature

### [PTL 1]

JP2005-133655A

### SUMMARY OF INVENTION

### Technical Problem

Operating machines having a general-purpose engine installed with an actuator (a stepper motor) electronically driving a throttle valve and an electronic governor controlling a rotation speed of the engine have been available. The actuator (the stepper motor) is fixed to a boss which is newly provided in the carburetor and thus, a frame of the throttle valve needs to be changed.

According to Patent Literature 1, in the engine equipped with the electronic governor control device, attaching parts for mounting a motor for driving the throttle control device 01, a sensor for detecting the turning degree of the reduction gear and the throttle valve 02 and so on are integrally formed into a unit.

Therefore, it is necessary to manufacture two different parts of the throttle body for the engine of electronic governor type and the engine of the mechanical governor type, thereby increasing a production cost (such as expense of a separate die, for production management and for production management).

In view of the issues above, an object of the present invention is to provide a device for lowering a cost of the throttle body of the carburetor that can be used for both the mechanical governor control device and the electronic governor control device.

### Solution to Problem

To achieve the above object of the present invention, the present invention provides an intake device for an engine which is equipped with an electronic governor for opening and closing a throttle valve of a carburetor provided in an intake path of the engine by means of an actuator, the device include, but not limited to:

the carburetor;

an air cleaner which is provided on an upstream side of the carburetor in the intake path to be adjacent to the carburetor;

a first thermal insulator which is provided on a downstream side of the carburetor in the intake path to be adjacent to the carburetor;

an intake pipe of the engine that is provided on a downstream side of the first thermal insulator in the intake path to be adjacent to the first thermal insulator;

a bracket which is provided between adjacent two of the air cleaner, the first thermal insulator, the carburetor and the intake pipe and which comprises a first portion extending outward from the intake path and a second portion extending orthogonally from an outer end of the first portion toward the carburetor, the first and second portions forming a L-shape.

the actuator which is installed on the second portion of the bracket and is connected to a drive shaft of the throttle valve to drive the throttle valve; and

a fastening member which fastens the air cleaner, the carburetor, the first thermal insulator and the first portion of the bracket to the intake pipe, the air cleaner, the carburetor, the first thermal insulator and the first portion being arranged linearly in the intake path.

With the structure, the first portion of the bracket for mounting the actuator actuating the throttle valve of the engine of the electronic governor type is provided between adjacent two of the air cleaner, the carburetor, the thermal insulator and the intake pipe, and the air cleaner, the carburetor, the bracket and the thermal insulator are fastened together to the intake pipe by the fastening member. In the case of the engine with the electronic governor, simply by newly providing the bracket to mount the actuator and arranging a portion of the bracket in the intake path, the same carburetor can be used for both of the engine equipped with the mechanical governor and the engine equipped with the electronic governor and thus, parts can be standardized. As a result, specification change of the engine can be handled while the real cost is reduced.

It is preferable in the present invention is that the first portion of the bracket is provided between the carburetor and the first thermal insulator, and that the second portion of the bracket has a through-hole into which a drive shaft of the actuator is inserted, the through-hole being arranged near a flexion where the bracket bends.

With this structure, an overhang of the second portion of the bracket is reduced. By this, the vibration from the engine is reduced, the actuator can smoothly actuate the drive shaft of the throttle valve and the vibration loaded on the actuator decreases, thereby improving the durability of the actuator.

The first thermal insulator is arranged between the intake pipe and the first portion of the bracket. Thus, heat conductivity from the intake pipe to the actuator is reduced, thereby improving the durability of the actuator.

It is preferable in the present invention that a second thermal insulator is provided between the second portion of the bracket and the actuator.

With this structure, the second thermal insulator prevents the heat from transferring from being conducted from the intake pipe of the engine to the actuator via the bracket, thereby securing the performance and the durability of the actuator.

It is preferable in the present invention that the bracket also includes a third portion which extends continuously from the second portion opposite to the first portion to form a C-shape, the third portion being provided between adjacent two of the air cleaner, the first thermal insulator, the carburetor and the intake pipe.

With this structure, the bracket for mounting the actuator which actuates the throttle valve is formed into the C-shape, each of the first portion and the third portion is arranged between adjacent two of the carburetor, the air cleaner on the upstream side of the carburetor in the intake path, the first thermal insulator on the downstream side of the carburetor in the intake path and the intake pipe on the downstream side of the first thermal insulator in the intake path.

In this manner, the second portion where the actuator is mounted is supported at both ends thereof, thereby improving rigidity of the portion where the actuator is mounted. Thus, the vibration from the engine is reduced, the actuator can smoothly actuate the drive shaft of the throttle valve and the vibration loaded on the actuator itself is reduced, thereby improving the durability of the actuator.

It is preferable in the present invention that the fastening member includes a stud bolt that is screwed into a screw hole formed on an adjacent surface of the intake pipe on an a side of the first thermal insulator to be fixed.

With this structure, the stud bolt is fixed to the intake pipe which is fixed to the engine. Thus, the intake path 12 can be formed simply by inserting the stud bolt through the mounting hole of each of the first thermal insulator, the bracket, the carburetor and the air cleaner in the order. Each component is supported by the stud bolt. Thus, it has installation ease.

### Advantageous Effects of Invention

According to the present invention, with the above structure, the first portion of the bracket where the actuator which actuates the throttle valve of the engine of the electronic governor type is mounted, is arranged between adjacent two of the air cleaner, the carburetor, the thermal insulator and the intake pipe which together form the intake path. The air cleaner, the carburetor and the thermal insulator are fastened to the intake pipe by the fastening member. Thus, simply by providing the bracket, the carburetor can be used for both of the engine equipped with the mechanical governor and the engine equipped with the electronic governor and thus, parts can be standardized. As a result, specification change of the engine can be handled while the real cost is reduced.

### BRIEF DESCRIPTION OF DRAWINGS

FIG. 1 is a schematic cross-sectional view of an intake structure of an engine in relation to a first preferred embodiment of the present invention.

FIG. 2A is a plan view of a bracket (a second portion) in relation to the first preferred embodiment of the present invention. FIG. 2B is a front view of FIG. 2A (a first portion). FIG. 2C is a side view of FIG. 2B.

FIG. 3 is a sectional view taken along a line Z-Z of FIG. 1 in relation to the first preferred embodiment.

FIG. 4 is a schematic cross-sectional view of an intake structure of an engine in relation to a second preferred embodiment of the present invention.

FIG. 5 is a schematic cross-sectional view of an intake structure of an engine in relation to a third preferred embodiment of the present invention.

FIG. 6 is a perspective view of a conventional throttle valve control device.

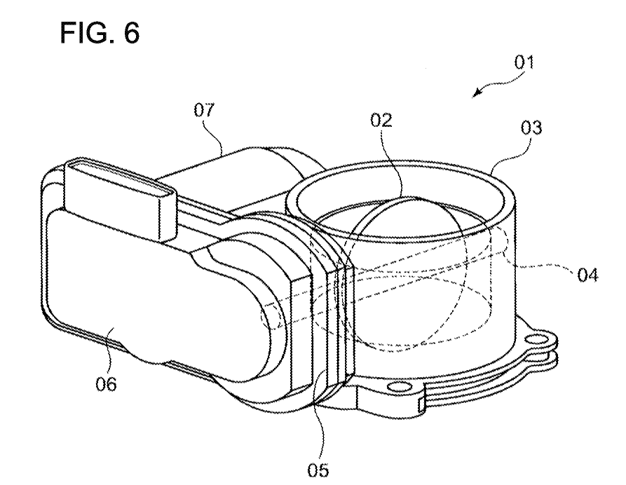

### DESCRIPTION OF EMBODIMENTS

A preferred embodiment of the present invention will now be described in detail with reference to the accompanying drawings. It is intended, however, that unless particularly specified, dimensions, materials, shape, its relative positions and the like shall be interpreted as illustrative only and not limitative of the scope of the present invention.

### First Preferred Embodiment

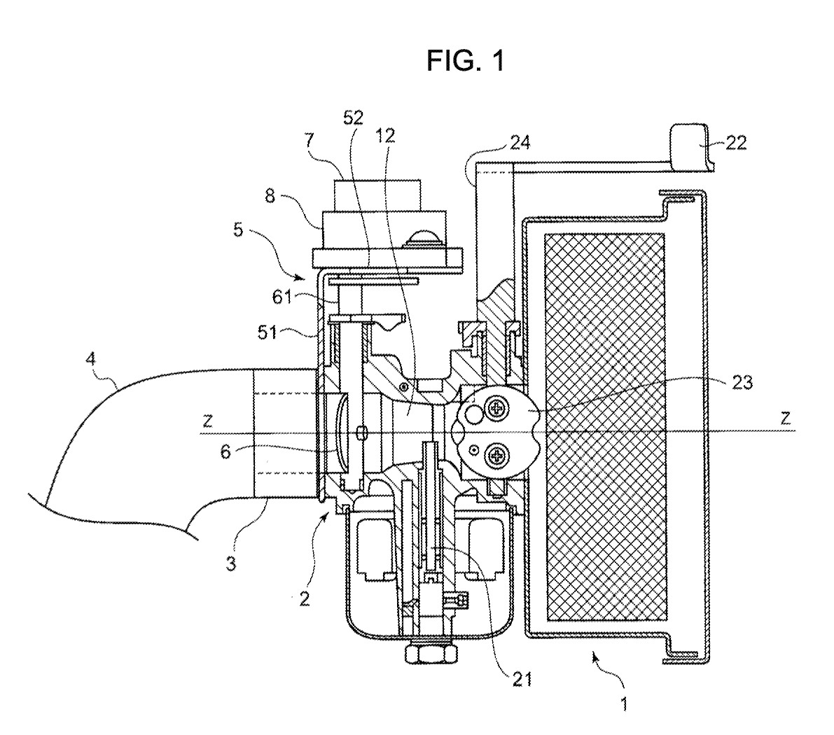

An intake structure of an engine equipped with an electronic governor in relation to a first preferred embodiment of the present invention is explained in reference to FIG. 1 to FIG. 3. FIG. 1 shows an air cleaner 1 which removes dust and rain water from external air and an carburetor 2 which is provided on a downstream side of the air cleaner 1 in an intake path 12 to be adjacent to the air cleaner and adjusts a mixture ratio of air and fuel from the air cleaner and a flow rate of mixture air to a combustion chamber of the engine based on a load and a rotation speed of the engine (not shown). On a downstream side of the carburetor 2 in the intake path 12 to be adjacent to the carburetor, a bracket 5 is provided to mount a stepper motor 7 which is an actuator opening and closing a throttle valve of the carburetor 2. On a downstream side of the bracket 5 in the intake path 12 to adjacent to the bracket 5, a first thermal insulator 3 is provided to block heat conduction from an intake pipe 4 of the engine. On a downstream side of the first thermal insulator 3 in the intake path 12 to be adjacent to the first thermal insulator 3, the intake path 4 is provided to lead the intake air to the combustion chamber (not shown) of the engine.

The carburetor 2 has a choke valve 23 and a throttle valve 6 that are arranged in series. When the choke valve 23 is closed by operating a choke lever 22 and turning a choke valve rotation shaft 24 to which the choke valve 23 is fixed to facilitate engine start-up, it increases a negative pressure in the carburetor 2 and increases an amount of fuel suctioned into the intake path 12 from a fuel nozzle 2 so as to improve engine starting performance. The throttle valve 6 controls the rotation speed and output of the engine in a normal operation of the engine.

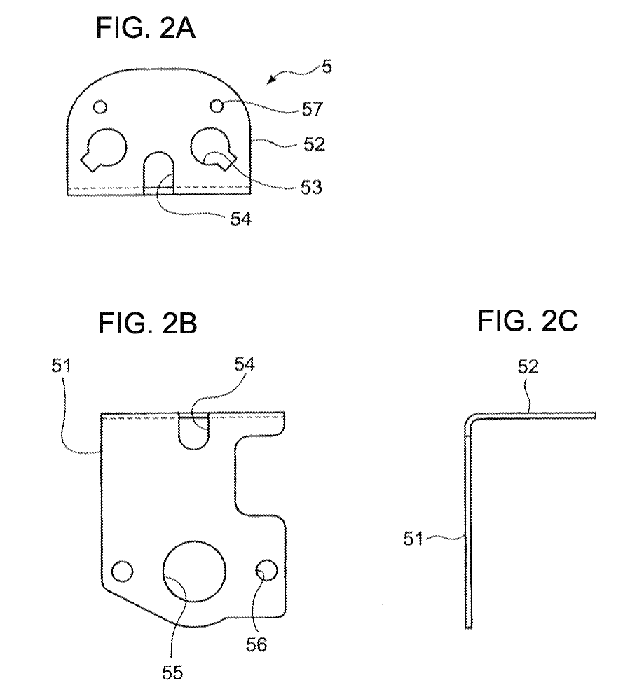

Between the carburetor 2 and the insulator 3, an intake-path forming portion which is a first portion of a L-shaped bracket 5 is provided. A detailed structure of the L-shaped bracket 5 is illustrated in FIG. 2.

The L-shaped bracket 5 is made of flat sheet metal. The L-shaped bracket 5 includes the intake-path forming portion which is the first portion extending outward from the intake path 12 and an actuator mounting portion 52 which is a second portion extending substantially orthogonally from an outer end of the intake-path forming portion 51

The intake-path forming portion 51 of the L-shaped bracket 5 has an intake-path hole 55 which forms a part of the intake path 12 and mounting holes 56 through which one end of each stud bolt 9 is inserted (see FIG. 2). In the preferred embodiment, two stud bolts 9 are arranged.

In the preferred embodiment, ore than one stud bolt 9 is provided. Thus, simply by inserting one end of each stud bolt 9 into a mounting hole of each component, it is possible to perform positioning of each component automatically, thereby improving reliability of assembling components.

The stepper motor 7 is an actuator which opens and closes the throttle valve 6 of the carburetor 2. The stepper motor 7 is provided on the actuator mounting portion 52 of the L-shaped bracket 5 via a second thermal insulator 8. The second thermal insulator 8 blocks heat conduction to the stepper motor 7 via the intake pipe 4, the first thermal insulator 3 and the bracket 5 from the engine.

On a side of the second thermal insulator 8 that is arranged on the actuator mounting portion 52, the second thermal insulator 8 has a projection for positioning (not shown). Meanwhile, the actuator mounting portion 52 of the bracket 5 has engaging holes 53, screw holes 57 and a through-hole 54. Each of the engaging holes 53 is shaped to receive the projection of the second thermal insulator 8. The screw holes 57 are formed to insert screws to mount the second thermal insulator 8. The through-hole 54 is formed in the actuator mounting portion 52 near a flexion where the bracket 5 bends and a drive shaft of the stepper motor 7 is inserted through the through-hole 54. The projection of the second thermal insulator 8 is engaged with the engaging hole 53 to position the second thermal insulator 8 to the actuator mounting portion 52 of the bracket 5.

The L-shaped bracket 5 shown in FIG. 2 has the flexion formed such that the intake-path forming portion 51 is orthogonal to the actuator mounting portion 52. The L-shaped bracket 5 may have a curved flexion or a pitched flexion with two flexion points.

The second thermal insulator 8 is placed to the actuator mounting portion 52 in such a state that the projection of the second thermal insulator 8 is engaged with the engaging hole 53 of the bracket. Thus, the drive shaft of the stepper motor 7 is inserted through the through-hole 54 formed in the second portion to be precisely connected to a rotation drive shaft 61 of the throttle valve 6.

The second thermal insulator 8 is made of hard resin material and thus the second thermal insulator 8 is unlikely to deform. Thus, the power of the drive power of the stepper can be firmly conveyed to the rotation drive shaft 61 of the throttle valve 6.

The hard resin material of the second thermal insulator 8 may be polyphenylene sulfide resin (PPS) or the like.

The bracket 5 has the through-hole 54 formed in the actuator mounting portion 52 near the flexion and the output shaft of the stepper motor 7 is inserted through the through-hole 54. The weight of the stepper motor 7 is loaded on a spot of the actuator mounting portion 52 that is nearer to the intake-path forming portion 51 (a vertical wall). Thus, it is possible to suppress vibration from the engine and transmit the drive power of the stepper motor 7 to the rotation drive shaft 61 of the throttle valve 6 smoothly. As the vibration of the stepper motor 7 is reduced, it has an advantage in durability of the stepper motor 7.

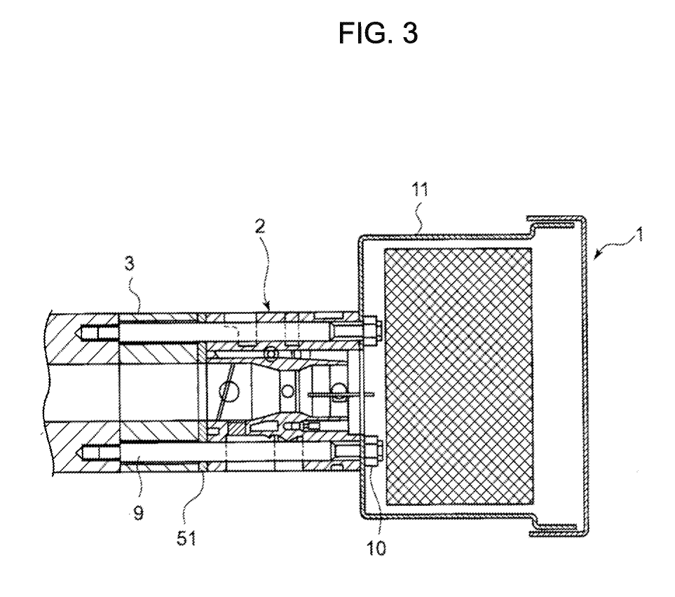

A structure of fixing each component forming the intake path 12 is shown in FIG. 3. As shown in FIG. 3, each of the air cleaner 1, the carburetor 2, the intake-path forming portion 51 of the bracket 5 and the first thermal insulator has an (not shown) through which the stud bolt 9 fixed to the intake pipe 4 is inserted. The stud bolt 9 is a part of a fastening member and the air cleaner 1, the carburetor 2, the intake-path forming portion 51 of the bracket 5 and the first thermal insulator are fastened together by a nut 10 from the air cleaner side.

The stud bolt 9 is screwed into a tap formed on a side adjacent to the first thermal insulator 3 to be fixed. In the first preferred embodiment, there are two taps and two stud bolts 9.

The assembling process is: 1) insert the stud bolt 9 screwed to the intake pip 4 through the mounting hole of each of the first thermal insulator 3, the intake-path forming portion 51 of the L-shaped bracket 5, the carburetor 2 and the air cleaner 1 in this order; and 2) fastening them by the nut via a flat washer and a spring washer (not shown) from an inner side of an air cleaner case 11 of the air cleaner 1.

The fastening member includes the stud bolt 9, the nut 10, the flat washer and the spring washer.

The first thermal insulator 3 is made of hard resin having heat resistance. The material used for the first thermal insulator 3 has such a hardness as well as thermal insulating properties that it does not deform when the one end of the stud bolt 9 is inserted through the mounting holes of the first thermal insulator 3, the carburetor 2 and the air cleaner 1 are inserted to the one end of the stud bolt 9 in this order and fastened by the nut 10 via the flat washer and the spring washer together with the intake pipe 4. For instance, the first thermal insulator 3 is made of polyphenylene sulfide resin or the like.

Next, the second thermal insulator to which the stepper motor 7 is arranged is fixed to the actuator mounting portion of the bracket 5. Thus, the output shaft of the stepper motor 7 can be connected to the rotation drive shaft 61 of the throttle valve 6.

The stud bolt 9 is fixed to the intake pipe 4 which is fixed to the engine. Thus, the intake path 12 can be formed simply by inserting the stud bolt 9 through the mounting hole of each of the first thermal insulator 3, the bracket 5, the carburetor 2 and the air cleaner in the order. Each component is supported by the stud bolt 9 and thus, it has installation ease.

The intake-path forming portion 51 of the bracket 5 is provided between adjacent two of the air cleaner 1, the carburetor 2, the first thermal insulator 3 and the intake pipe 4 which from the intake path 12, and the air cleaner 1, the carburetor 2, the intake-path forming portion 51 and the first thermal insulator 3 are fastened together to the intake pipe 4 by the stud bolt 9 and the nut 10. Thus, simply by providing the bracket to mount the stepper motor 7 for opening and closing the throttle valve 6, the carburetor can be used for both of the engine equipped with the mechanical governor and the engine equipped with the electronic governor and thus, parts can be standardized. As a result, specification change of the engine can be handled while the real cost is reduced.

The bracket 5 is a flat sheet metal folded into L-shape. As the change in size of the intake path 12 in the axial direction is little, it is not necessary to change the layout of the engine unit or to change the length of the stud bolt 9. Using the same parts for both types of engine can reduce the cost.

### Second Preferred Embodiment

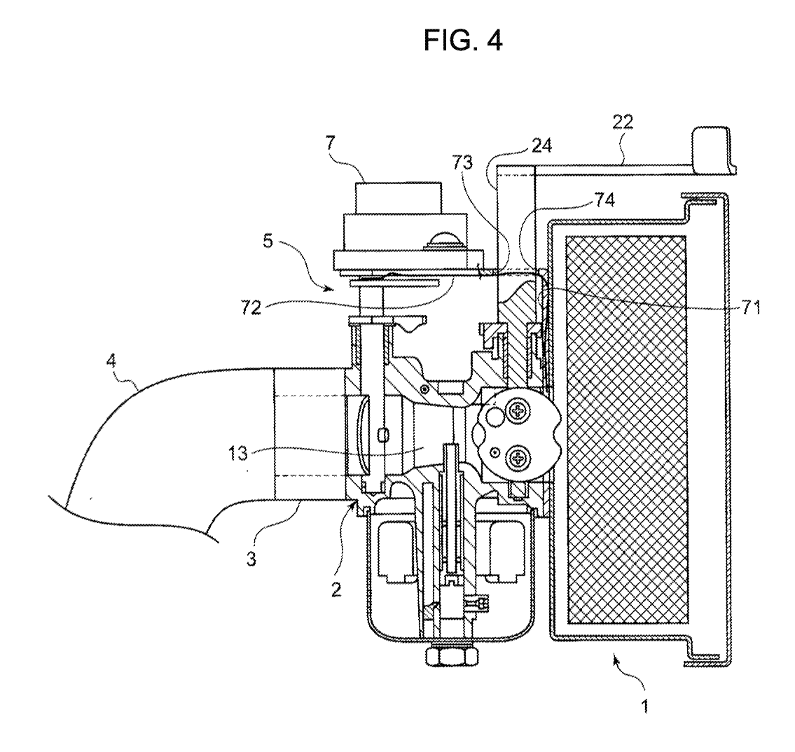

An intake structure of an engine in relation to a second preferred embodiment of the present invention is explained in reference to FIG. 4.

The same components that are described in the first preferred embodiment are indicated with the same reference numerals.

FIG. 4 is a schematic cross-sectional view of an intake structure of an engine in relation to the second preferred embodiment of the present invention.

As shown in FIG. 4, an intake-path forming portion 71 which is a first portion of a L-shaped bracket 70 is provided on a downstream side of the air cleaner 1 an the intake path 13 to be adjacent to the air cleaner 1. The bracket 70 is made of a flat metal sheet folded into L-shape. The L-shaped bracket 70 includes the intake-path forming portion 71 and an actuator mounting portion 72 which is the second portion extending substantially orthogonally from the outer end of the intake-path forming portion 71. To the actuator-mounting portion 72, mounted is the stepper motor 7 which is the actuator for opening and closing the throttle valve 6 of the carburetor 2.

On the downstream side of the intake-path forming portion 71 in the intake path, the carburetor is provided to be adjacent to the intake-path forming portion 71. On the downstream side of the carburetor 2 in the intake path 12, the first thermal insulator 3 is provided adjacent to the carburetor 2 so as to block heat conductivity from the intake pipe 4 of the engine. The intake path 4 is provided adjacent to the first thermal insulator 3 to lead the intake air to the combustion chamber (not shown) of the engine. The air cleaner 1, the intake-path forming portion 71, the carburetor 2, the first thermal insulator 3 and the intake pipe 4 together form the intake path 13.

The stepper motor 7 is affected by the heat from the engine. Thus, the intake-path forming portion 71 of the L-shaped bracket 70 is arranged away from the intake pipe of the engine which is a heat source so as to avoid the heat from the engine affecting the stepper motor 7.

Different from the first preferred embodiment, in the second preferred embodiment, the intake-path forming portion 71 of the bracket 70 made of flat sheet metal is arranged between the air cleaner 1 and the carburetor 2 in the intake path 13. The rest of the mounting structure of each component forming the intake path 13 is the same as that of the first preferred embodiment except for the configurations described below.

A through-hole 74 through which the drive shaft of the stepper motor 7 is inserted, is formed in the actuator mounting portion 72 on an opposite side of the intake-path forming portion 71 (a downstream side). Another through-hole 73 is formed in the actuator mounting portion 72 near the flexion to avoid an interference with a rotation shaft 24 of the choke valve which rotates by means of a choke lever 22.

Beside that, the structure of mounting the stepper motor to the actuator mounting portion 72 via the second thermal insulator 8 and of providing the bracket 70 in the intake path 13 is the same as that of the first preferred embodiment and thus, is not explained further.

According to the second preferred embodiment, the intake-path forming portion 71 of the bracket 70 is arranged between the air cleaner 1 and the carburetor 2. The bracket is arranged away from the engine which is a heat source and thus, the negative affect of the heat on the stepper motor 7 is small and the stepper motor 7 can deliver full performance.

### Third Preferred Embodiment

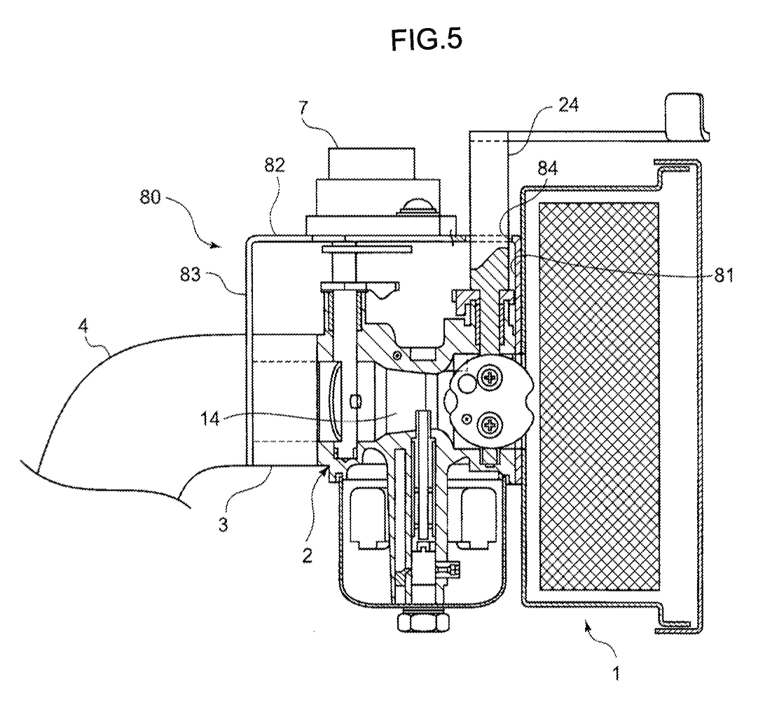

An intake structure of an engine in relation to a third preferred embodiment of the present invention is explained in reference to FIG. 5.

The same components that are described in the first preferred embodiment are indicated with the same reference numerals.

FIG. 5 is a schematic cross-sectional view of an intake structure of an engine in relation to the third preferred embodiment of the present invention.

As shown in FIG. 5, a first intake-path forming portion 81 which is a first portion of a bracket 80 is provided on a downstream side of the air cleaner 1 in an intake path 13 to be adjacent to the air cleaner 1. The bracket 80 is made of a metal sheet. The bracket 80 includes the first intake-path forming portion 81 and an actuator mounting portion 82 which is the second portion extending substantially orthogonally from the outer end of the first intake-path forming portion 81 toward the carburetor 2. To the actuator mounting portion 82, mounted is the stepper motor 7 which is the actuator for opening and closing the throttle valve 6 of the carburetor 2.

The bracket 80 also includes a second intake-path forming portion 83 which extends continuously from a downstream end of the actuator mounting portion 82 opposite to the first intake-path forming portion 81. The first intake-path forming portion 81, the actuator mounting portion 82 and the second intake-path forming portion 83 constitute the C-shaped bracket 80 made of flat sheet metal. The second intake-path forming portion 83 is provided between the first thermal insulator 3 and the intake pipe 4.

The air cleaner 1, the first intake-path forming portion 81, the carburetor 2, the first thermal insulator 3, the second intake-path forming portion 83 and the intake pipe 4 together form the intake path 14.

Different from the first preferred embodiment, in the third preferred embodiment, the bracket 80 is formed such that the first intake-path forming portion 81 and the second intake path forming portion 83 extend orthogonally toward the intake path 14 from both ends of the actuator mounting portion 82 respectively in the direction of the intake path 14 to form almost C-shape.

A through-hole 84 is formed in the actuator mounting portion 82 near the flexion on a side of the first intake-path forming portion 81 to avoid an interference with the rotation shaft 24 of the choke valve which rotates by means of the choke lever 22.

In the third preferred embodiment, the C-shaped bracket 80 straddles the carburetor 2 in the direction of the intake path 14 with the first and second intake-path forming portions 81 and 83 on both sides of the carburetor 2 in the intake path 14 and the actuator mounting portion 82 over the carburetor 2.

As shown in FIG. 5, in the third preferred embodiment, the bracket 80 is made of flat sheet metal and arranged with the first intake-path forming portion 81 between the air cleaner 1 and the carburetor 2 and the second intake-path forming portion 83 between the first thermal insulator and the intake pipe 4 in the intake path 14.

The mounting structure of mounting each component forming the intake path 14 to the intake pipe 4 and the structure of mounting the stepper motor 7 to the bracket 80 via the second insulator are practically the same as those of the first preferred embodiment except for the configurations described below.

According to the third preferred embodiment, the actuator mounting portion 82 to which the stepper motor is mounted is supported from both ends thereof. The vibration from the engine is reduced, the actuator can smoothly actuate the drive shaft of the throttle valve and the vibration loaded on the stepper motor itself is reduced, thereby improving the durability of the stepper motor.

The same effects can still be achieved in any of the cases as long as the second intake-path forming portion 83 is arranged adjacent two of the intake pipe, the first insulator and the carburetor 2 and the actuator mounting portion 82 is arranged over the carburetor in the direction of the intake path 14.

### INDUSTRIAL APPLICABILITY

In order to standardize the carburetor for both of the engine with the electronic governor and the engine with the mechanical governor, the bracket with the actuator for actuating the throttle valve mounted thereon needs to be installed in the intake path 12 so as to use the same parts for both types of the engines.

In the above preferred embodiments, the present invention is applied to the general-purpose engine. However, this is not limitative and the present invention is applicable to a regular engine as well.

1. An intake device for an engine which is equipped with an electronic governor for opening and closing a throttle valve of a carburetor provided in an intake path of the engine by means of an actuator, the device comprising:
the carburetor;
an air cleaner which is provided on an upstream side of the carburetor in the intake path to be adjacent to the carburetor;
a first thermal insulator which is provided on a downstream side of the carburetor in the intake path to be adjacent to the carburetor;
an intake pipe of the engine that is provided on a downstream side of the first thermal insulator in the intake path to be adjacent to the first thermal insulator;
a bracket which is provided between adjacent two of the air cleaner, the first thermal insulator, the carburetor and the intake pipe and which comprises a first portion extending outward from the intake path and a second portion extending orthogonally from an outer end of the first portion toward the carburetor, the first and second portions forming a L-shape;
the actuator which is installed on the second portion of the bracket and is connected to a drive shaft of the throttle valve to drive the throttle valve; and
a fastening member which fastens the air cleaner, the carburetor, the first thermal insulator and the first portion of the bracket to the intake pipe, the air cleaner, the carburetor, the first thermal insulator and the first portion being arranged linearly in the intake path.

2. The intake device for the engine according to claim 1,
wherein the first portion of the bracket is provided between the carburetor and the first thermal insulator, and
wherein the second portion of the bracket has a through-hole into which a drive shaft of the actuator is inserted, the through-hole being arranged near a flexion where the bracket bends.

3. The intake device for the engine according to claim 1, further comprising:
a second thermal insulator which is provided between the second portion of the bracket and the actuator.

4. The intake device for the engine according to claim 1,
wherein the bracket further comprises a third portion which extends continuously from the second portion opposite to the first portion to form a C-shape, the third portion being provided between adjacent two of the air cleaner, the first thermal insulator, the carburetor and the intake pipe.

5. The intake device for the engine according to claim 1,
wherein the fastening member includes a stud bolt that is screwed into a screw hole formed on an adjacent surface of the intake pipe on an a side of the first thermal insulator to be fixed.
